(19) United States
(12) Patent Application Publication
(10) Pub. No.: US 2023/0405896 A1
(43) Pub. Date: Dec. 21, 2023

(54) FIXING DEVICE AND MECHANICAL SYSTEM

(71) Applicant: FANUC CORPORATION, Minamitsuru-gun (JP)

(72) Inventor: Nobuatsu TSUCHIYA, Minamitsuru-gun, Yamanashi-ken (JP)

(21) Appl. No.: 18/035,351

(22) PCT Filed: Nov. 5, 2021
(86) PCT No.: PCT/JP2021/040704

§ 371 Date: May 4, 2023

(30) Foreign Application Priority Data
Nov. 11, 2020 (JP) 2020-188090

(51) Int. Cl. B29C 45/42; B29C 45/03

(52) U.S. Cl. CPC B29C 45/42; B29C 2045/1792; B29C 45/03

(57) ABSTRACT

A fixing device includes: a coupling mechanism that includes a pin member extending in a direction orthogonal to an installation surface, and couples a first mount and a second mount using the pin member; and a rotation restricting part that restricts the second mount from rotating about the pin axis relative to the first mount.

### TECHNICAL FIELD

The present invention relates to a fixing device and a mechanical system.

### BACKGROUND ART

JP 2016-203484 A discloses an injection molding system in which a pedestal (robot pedestal) on which a robot is placed is fixed to a pedestal (molding machine base) of an injection molding machine. The robot pedestal surrounds a clamping device of the injection molding machine mounted on the molding machine base. The robot takes out a molded article from an opening provided above the clamping device.

### SUMMARY OF THE INVENTION

However, in the case of an injection molding machine in which an opening for taking out a molded article is provided in a cover covering the side surface of the clamping device, even if the robot pedestal is fixed to the molding machine base, the molded article cannot be taken out. Therefore, there is required a fixing device capable of fixing to the second pedestal a first pedestal (robot pedestal (or molding machine base)) that is arranged at a position away from the side surface of the first pedestal (molding machine base (or robot pedestal)).

Accordingly, it is an object of the present invention to provide a fixing device and a mechanical system capable of fixing a second pedestal arranged at a position apart from a side surface of the first pedestal to the first pedestal.

The first aspect of the present invention is a fixing device for fixing a second pedestal to a first pedestal including a coupling mechanism that includes a pin member extending in a direction perpendicular to an installation surface on which the frame is installed and couples the first pedestal and the second pedestal with the pin member, and a rotation suppressing portion that suppresses rotation of the second pedestal about the pin axis of the pin member with respect to the first pedestal.

A second aspect of the present invention is a mechanical system including the fixing device, an industrial machine including the first pedestal, and a robot placed on the second pedestal.

According to an aspect of the present invention, by using a pin member extending in a direction perpendicular to the installation surface, a second pedestal arranged at a position apart from the side surface of the first pedestal can be coupled to the first pedestal without rotating. Therefore, the second pedestal arranged at a position away from the side surface of the first pedestal can be fixed to the first pedestal.

### BRIEF DESCRIPTION OF DRAWINGS

FIG. 1 is a side view illustrating an embodiment of a mechanical system;

FIG. 2 is a schematic diagram showing a state in which a caster touches the ground and a leg is suspended;

FIG. 3 is a schematic diagram showing a state in which the leg touches the ground and the caster is suspended;

FIG. 4 is a schematic diagram showing a fixing device;

FIG. 5A shows a second pedestal of the fixing device and FIG. 5B shows a first pedestal of the fixing device;

FIG. 6 is a diagram showing a state in which a pin member is guided by a guide member;

FIG. 7 is a diagram showing a state in which the pin member is positioned above an insertion hole of a pin receiving member;

FIG. 8 is a diagram showing a state in which the pin member is inserted into the insertion hole of the pin receiving member;

FIG. 9 is a diagram showing a state in which the pin member is inserted into the insertion hole of the pin receiving member from a direction along a pin axis of the pin member;

FIG. 10 is a diagram showing how the caster and the leg are raised and lowered;

FIG. 11A is a diagram showing part of a first coupling unit of Modification 1 and FIG. 11B is a cross-sectional view taken along line XIB-XIB;

FIG. 12 is a diagram showing part of a first coupling unit of Modification 2;

FIG. 13 is a schematic diagram showing a modification of a rotation suppressing portion from the same viewpoint as FIG. 9;

FIG. 14 is a schematic diagram showing a case where a plurality of coupling mechanisms are provided;

FIG. 15 is a diagram showing a modification of the fixing device from the same viewpoint as FIG. 6; and

FIG. 16 is a diagram showing another modification of the fixing device.

### DETAILED DESCRIPTION OF THE INVENTION

The embodiments of the present invention will be described in detail below with reference to the accompanying drawings.

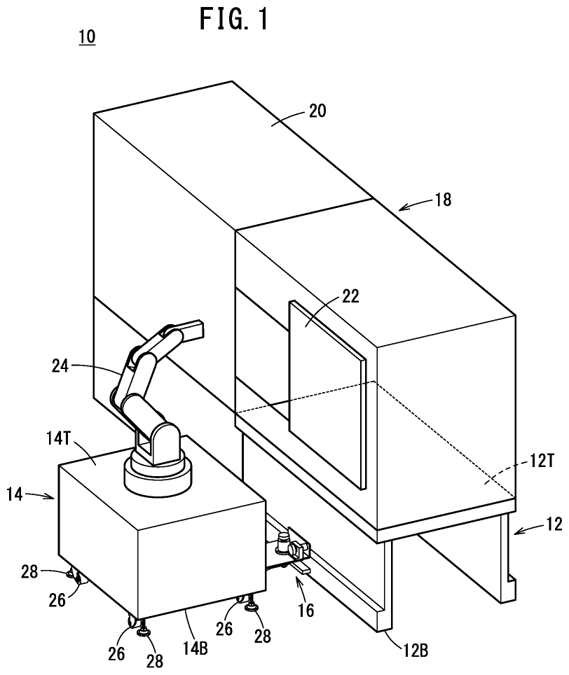

FIG. 1 is a side view showing an embodiment of a mechanical system 10. A mechanical system 10 includes a first pedestal 12, a second pedestal 14, and a fixing device 16 for fixing the second pedestal 14 to the first pedestal 12.

The first pedestal 12 is a machine base for an industrial machine. The industrial machine may be an injection molding machine 18 (FIG. 1) that injects molding material into a cavity of a mold to form a molded article. Further, the industrial machine may be a machine tool that processes a target object with a tool. In the case of this embodiment, the first pedestal 12 is a machine base for the injection molding machine 18. Hereinafter, the first pedestal 12 is referred to as a molding machine base 12.

The molding machine base 12 is provided with a protective cover 20 for protecting a main body of the injection molding machine 18. The main body of the injection molding machine 18 includes a clamping device for opening and closing a mold and an injection device for injecting a molding material into a cavity of the mold. The main body of the injection molding machine 18 is mounted on a mounting surface (upper surface) 12T of the molding machine base 12. An opening/closing door 22 is provided on a side surface of the protective cover 20 sandwiched between the upper surface of the protective cover 20 and the mounting surface 12T of the molding machine base 12. The opening/closing door 22 is opened and closed based on a signal output from a control device of the injection molding machine 18.

The second pedestal 14 is a pedestal on which an associated device that works together with the industrial machine is placed. The associated device may be a robot 24 (FIG. 1). The associated device may also be a supply device for supplying fluid such as air to the industrial machine. Further, the related device may be a power magnetics cabinet. The power magnetics cabinet accommodates a motor amplifier of a motor used for an industrial machine, an electromagnetic switch for supplying power to the industrial machine, and the like. In the case of this embodiment, the second pedestal 14 is a pedestal on which the robot 24 is placed. Hereinafter, the second pedestal 14 is referred to as a robot pedestal 14. The robot 24 can take out a molded article molded by the injection molding machine 18 to the outside through the opening/closing door 22 of the protective cover 20.

A plurality of legs 28 are provided on a lower surface 14B of the robot pedestal 14. The plurality of legs 28 support the robot pedestal 14. The configuration of each of the plurality of legs 28 is substantially the same. Each of the legs 28 is provided with a caster 26. A plurality of casters 26 can move the robot pedestal 14. The configuration of each of the plurality of casters 26 is substantially the same.

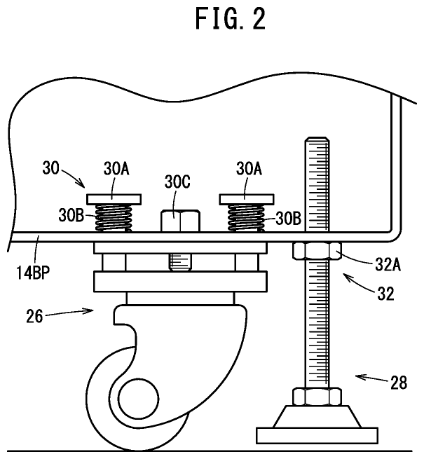

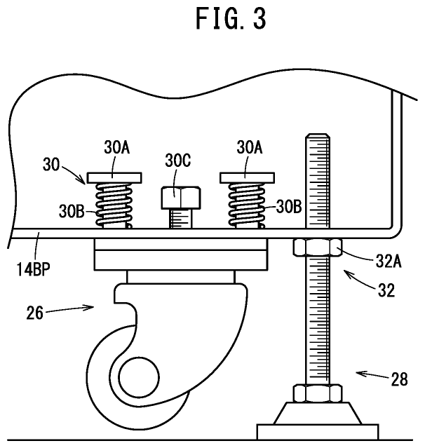

FIG. 2 is a schematic diagram showing a state in which the caster 26 touches the ground and the leg 28 is suspended. FIG. 3 is a schematic view showing a state in which the leg 28 touches the ground and the caster 26 is suspended.

The caster 26 is provided with an adjuster 30. The adjuster adjusts the position of the caster 26 with respect to the lower surface 14B of the robot pedestal 14. The structure of the adjuster 30 is not particularly limited. FIGS. 2 and 3 show an example of the structure of the adjuster 30 having a stopper a spring 30B, and a jack bolt 30C. The stopper 30A is provided at an end portion of a rod member of the caster 26 that penetrates the bottom plate 14BP of the robot pedestal 14. The spring 30B is provided between the bottom plate 14BP and the stopper 30A. The jack bolt 30C penetrates through the bottom plate 14BP of the robot pedestal 14 and comes into contact with the caster 26. When the jack bolt 30C rotates clockwise (or counterclockwise), the caster 26 is lifted from an installation surface on which the robot pedestal 14 is installed. When the jack bolt 30C rotates counterclockwise (or clockwise), the caster 26 is lowered toward the installation surface.

The leg 28 is provided with an adjuster 32. The adjuster 32 adjusts the height of the leg 28 from the installation surface on which the robot pedestal 14 is installed. The structure of the adjuster 32 is not particularly limited. FIGS. 2 and 3 show an example of the structure of the adjuster 32 having a nut 32A. The nut 32A is engaged with a screw formed on the outer peripheral surface of the leg 28. When the nut 32A is rotated clockwise (or counterclockwise), the leg 28 is lifted from the installation surface on which the robot pedestal 14 is installed, and when the nut 32A is rotated counterclockwise (or clockwise), the leg 28 is lowered toward the installation surface.

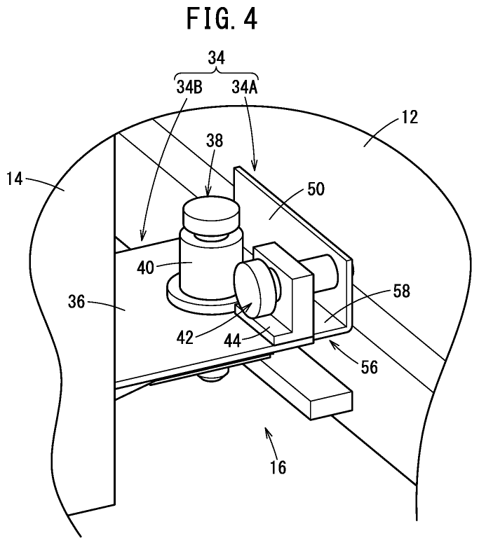

FIG. 4 is a schematic diagram showing the fixing device 16. The fixing device 16 is provided with a coupling mechanism 34 for coupling the molding machine base 12 and the robot pedestal 14 with each other. The coupling mechanism 34 includes a first coupling unit 34A provided on the molding machine base 12 and a second coupling unit 34B provided on the robot pedestal 14.

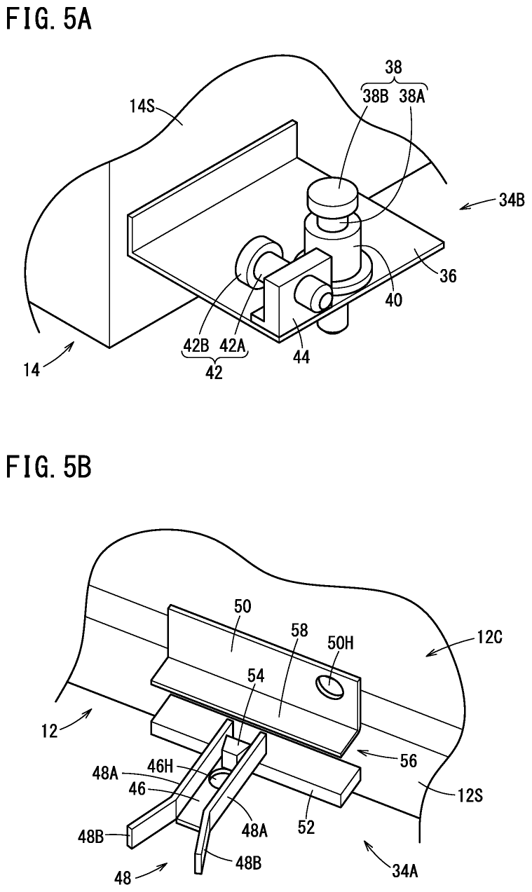

FIG. 5A is the diagram showing the robot pedestal 14 of the fixing device 16. FIG. 5B is the diagram showing the molding machine base 12 of the fixing device 16. The second coupling unit 34B is attached to a side surface 14S (see FIG. 5A) of the robot pedestal 14 sandwiched between a placing surface 14T (FIG. 1) of the robot pedestal 14 and the lower surface 14B (FIG. 1) of the robot pedestal 14. The lower surface 14B of the robot pedestal 14 is a surface opposite to the placing surface 14T of the robot pedestal 14. The second coupling unit 34B includes a base plate 36, a pin member 38, a pin support member 40, a second pin member 42, and a second pin support member 44.

The base plate 36 is fixed to the robot pedestal 14. The base plate 36 has a portion that extends substantially parallel to the installation surface on which the robot pedestal 14 is installed.

The pin member 38 has a pin 38A and a pinhead 38B. The pin 38A extends in a direction perpendicular to the installation surface on which the robot pedestal 14 is installed and penetrates the base plate 36. The pinhead 38B is provided at an end portion of the pin 38A on the opposite side to the end portion of the pin 38A facing the installation surface on which the robot pedestal 14 is installed. Note that the pinhead 38B may be omitted.

The pin support member 40 is fixed to the base plate 36. The pin support member 40 supports the pin member 38 to be slidable along the pin axis (axis of the pin 38A) of the pin member 38. When the pin member 38 has a pinhead 38B, the end of the pin support member 40 opposite to the end of the pin support member 40 facing the base plate 36 functions as a stopper for the pinhead 38B.

The second pin member 42 has a pin 42A and a pinhead 42B. The pin 42A extends in a direction intersecting the pin axis of the pin member 38. In the case of this embodiment, the pin 42A extends in a direction substantially perpendicular to each of the side surface 14S of the robot pedestal 14 and the pin axis of the pin member 38. The pinhead 42B is provided at an end portion of the pin 42A facing the side surface 14S of the robot pedestal 14. Note that the pinhead 42B may be omitted.

The second pin support member 44 is fixed to the base plate 36. The second pin support member 44 supports the second pin member 42 to be slidable along the pin axis (axis of the pin 42A) of the second pin member 42. When the second pin member 42 has the pinhead 42B, the end portion of the second pin support member 44 facing the side surface 14S of the robot pedestal 14 functions as a stopper for the pinhead 42B.

The first coupling unit 34A is attached to the side surface 12S (see FIG. 5B) sandwiched between the mounting surface 12T (FIG. 1) of the molding machine base 12 and the lower surface 12B (FIG. 1) of the molding machine base 12. The lower surface 12B of the molding machine base 12 is a surface opposite to the mounting surface 12T of the molding machine base 12. The first coupling unit 34A has a pin receiving member 46, a guide member 48, and a second pin receiving member 50.

The pin receiving member 46 is a member for receiving the pin member 38. The pin receiving member 46 has an insertion hole 46H through which the pin 38A of the pin member 38 is inserted. The insertion hole 46H extends in a direction perpendicular to the installation surface on which the molding machine base 12 is installed. The insertion hole 46H may pass through the pin receiving member 46. Further, the insertion hole 46H may be formed as a recess extending from the surface (upper surface) into which the pin member 38 is inserted toward the back surface (lower surface) but not reaching the back surface. The pinhead 38B of the pin member 38 cannot enter the insertion hole 46H. The pin receiving member 46 is fixed to the molding machine base 12 via a support member 52. The support member 52 may be omitted. When the support member 52 is not provided, the pin receiving member 46 is fixed directly to the molding machine base 12.

The guide member 48 guides the pin 38A of the pin member 38 to the insertion hole 46H of the pin receiving member 46. The guide member 48 is fixed to the pin receiving member 46. The guide member 48 has a pair of first rails 48A and a pair of second rails 48B.

The pair of first rails 48A extend in one direction with an interval therebetween. The insertion hole 46H for the pin receiving member 46 is disposed between one of the pair of first rails 48A and the other of the first rails 48A. The insertion hole 46H is positioned near the ends of the pair of first rails 48A. The pair of second rails 48B are provided at the ends of the pair of first rails 48A opposite to the ends of the pair of first rails 48A facing the side surface 12S of the molding machine base 12.

The pair of second rails 48B spreads in a manner so that the distance between the pair of the second rails 48B increases as the second rails 48B are further away from the insertion hole 46H of the pin receiving member 46. The end portions of the pair of second rails 48B opposite to the end portions of the pair of second rails 48B connected to the end portions of the pair of first rails 48A are open. The pin receiving member 46 may or may not be disposed below the pair of second rails 48B. The lower sides of the pair of second rails 48B face an installation surface on which the molding machine base 12 is installed. FIG. 5B shows an example in which there is no pin receiving member 46 below the pair of second rails 48B.

A stopper 54 may be provided between the pair of first rails 48A and at a position closer to the side surface 12S of the molding machine base 12 than the insertion hole 46H of the pin receiving member 46 is. FIG. 5B shows an example in which the stopper 54 is provided. The stopper 54 stops the pin 38A of the pin member 38 guided by the guide member 48 at a position where the pin 38A can be inserted into the insertion hole 46H of the pin receiving member 46. The stopper 54 is fixed to at least one of the pin receiving member 46 and the guide member 48.

The second pin receiving member 50 is a member for receiving the second pin member 42. The second pin receiving member 50 has an insertion hole 50H through which the pin 42A of the second pin member 42 is inserted. The insertion hole 50H extends in a direction perpendicular to the side surface 12S of the molding machine base 12. The insertion hole 50H may pass through the second pin receiving member 50. Further, the insertion hole 50H may be formed as a recess extending from the surface (upper surface) into which the second pin member 42 is inserted toward the back surface (lower surface) but not reaching the back surface. The pinhead 42B of the second pin member 42 cannot enter the insertion hole 50H. The second pin receiving member 50 is fixed to the side surface 12S of the molding machine base 12 via the support member 52. The second pin receiving member 50 has a protruding portion protruding to a recessed portion 12C formed on the side surface 12S of the molding machine base 12, and the protruding portion is formed with the insertion hole 50H.

The fixing device 16 includes a rotation suppressing portion 56 (see FIG. 4) in addition to the coupling mechanism 34. The rotation suppressing portion 56 suppresses rotation of the robot pedestal 14 about the pin axis of the pin member 38 with respect to the molding machine base 12. The rotation suppressing portion 56 includes a contact member 58 (see FIG. The contact member 58 is provided on the molding machine base 12. When the molding machine base 12 and the robot pedestal 14 are coupled by the coupling mechanism 34, the contact member 58 makes surface-contact with the robot pedestal 14 over both sides of the pin axis of the pin member 38.

The contact member 58 may be in surface-contact with the side surface 14S of the robot pedestal 14. The contact member 58 may be in surface-contact with part of the second coupling unit 34B. In this embodiment, the contact member 58 is in surface-contact with the base plate 36 of the second coupling unit 34B (see FIG. 4). Further, in the present embodiment, the contact member 58 is formed integrally with the second pin receiving member 50, but it may be formed separately from the second pin receiving member 50.

Next, a method of fixing the robot pedestal 14 to the molding machine base 12 will be described. The first coupling unit 34A of the fixing device 16 is attached to the side surface 12S of the molding machine base 12, and the second coupling unit 34B of the fixing device 16 is attached to the side surface 14S of the robot pedestal 14.

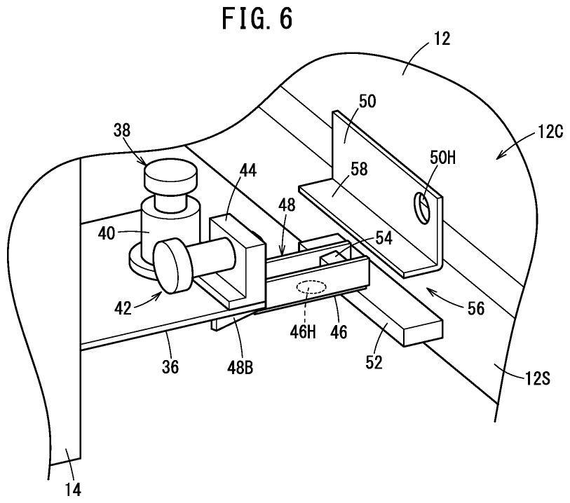

First, the operator moves the robot pedestal 14 to place the pin member 38 of the second coupling unit 34B between the pair of second rails 48B of the first coupling unit 34A (see FIG. 6). In this case, each of the plurality of casters 26 of the robot pedestal 14 touches the installation surface, and each of the plurality of legs 28 does not touch the installation surface (see FIG. 2).

When the pin member 38 enters between the pair of second rails 48B, the operator moves the robot pedestal 14 to place the pin member 38 above the insertion hole 46H formed in the pin receiving member 46. In this case, the guide member 48 guides the pin member 38 to the insertion hole 46H. Thus, the pin member 38 can be guided to the insertion hole 46H while the operator is not required to move the robot pedestal 14 watching the pin member 38.

The guide member 48 includes the pair of first rails 48A and the pair of second rails 48B. The pair of second rails 48B are provided at the end portions of the pair of first rails 48A on the opposite side from the end portions of the pair of first rails 48A near the insertion holes 46H of the pin receiving member 46. Further, the pair of second rails 48B is widened in a manner so that the distance between the pair of second rails 48B increases as the second rails 48B are further apart from the insertion hole 46H of the pin receiving member 46. As a result, the operator can easily insert the pin member 38 between the pair of first rails 48A in comparison with the case where the pair of second rails 48B is not provided. That is, the operator can insert the pin member 38 between the pair of first rails 48A while the operator is not required to move the robot pedestal 14 watching the pin member 38.

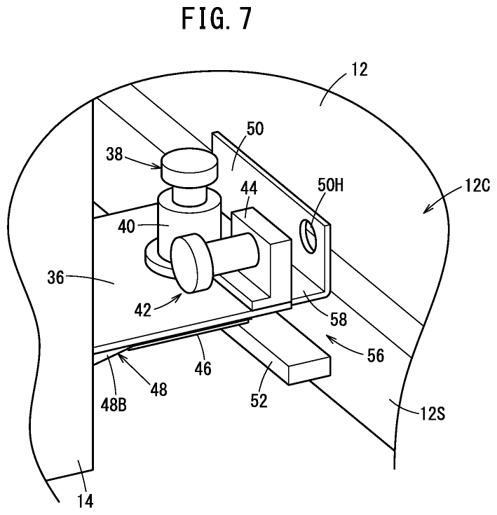

When the pin member 38 comes into contact with the stopper 54 of the first coupling unit 34A, the pin member 38 is in a state in which the robot pedestal 14 cannot move toward the molding machine base 12. In this state, the pin member 38 is positioned above the insertion hole 46H of the pin receiving member 46 (see FIG. 7). That is, since the stopper 54 is provided, the operator can place the pin member 38 above the insertion hole 46H while the operator is not required to move the robot pedestal 14 watching the pin member 38.

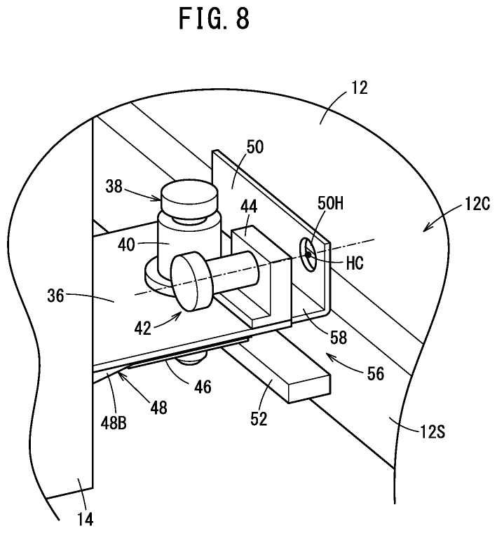

When the pin member 38 is placed above the insertion hole 46H, the pin member 38 is inserted into the insertion hole 46H (see FIG. 8). The insertion of the pin member 38 into the insertion hole 46H may be performed by an operator. Further, the pin member 38 may be inserted into the insertion hole 46H by a motor for sliding the pin member 38.

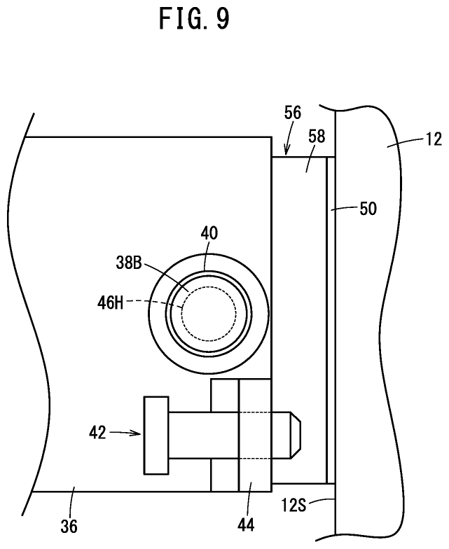

When the pin member 38 is inserted into the insertion hole 46H, the molding machine base 12 and the robot pedestal 14 are coupled with each other. In this state, the contact member 58 makes surface-contact with the base plate 36 of the second coupling unit 34B over both sides of the pin axis of the pin member 38 (see FIG. 9). Thus, the robot pedestal 14 can be prevented from rotating about the pin axis of the pin member 38 with respect to the molding machine base 12.

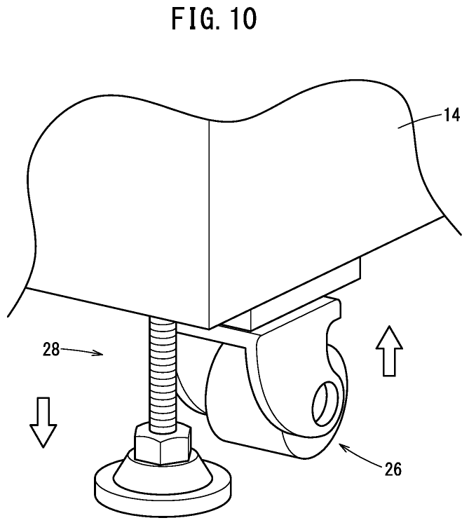

After the pin member 38 is inserted into the insertion hole 46H, the operator adjusts the adjuster 30 (FIG. 3) and the adjuster 32 (FIG. 3) so that the leg 28 touches the installation surface and the caster 26 is apart from the installation surface (see FIG. 10). In this state, the operator adjusts the height from the installation surface on which the robot pedestal 14 is installed.

Specifically, the height from the installation surface is adjusted by the adjuster 32 so that the pin axis of the second pin member 42 is aligned with the center HC (FIG. 8) of the insertion hole 50H of the second pin receiving member 50. In other words, the second pin member 42 determines the position of the robot pedestal 14 in a manner so that the height of the robot pedestal 14 relative to the molding machine base 12 from the installation surface becomes a target height. Thus, the height of the robot pedestal 14 relative to the molding machine base 12 from the installation surface can be accurately adjusted.

When the pin shaft of the second pin member 42 is inserted through the insertion hole 50H of the second pin receiving member 50, the second pin member 42 can suppress the relative positional displacement in the height direction between the molding machine base 12 and the robot pedestal 14. In this case, the second pin member 42 also functions as the rotation suppressing portion 56 for suppressing rotation of the robot pedestal 14 about the pin axis of the pin member 38. In other words, the rotation suppressing portion 56 includes the second pin member 42 and, together with the contact member 58, suppresses rotation of the robot pedestal 14 with respect to the molding machine base 12. Thus, in comparison with the case where the rotation of the robot pedestal 14 with respect to the molding machine base 12 is suppressed only by the contact member 58, the force for suppressing the rotation can be increased.

As described above, the fixing device 16 of the present embodiment includes the coupling mechanism 34 and the rotation suppressing portion 56. The coupling mechanism 34 couples the molding machine base 12 and the robot pedestal 14 with each other using the pin member 38. The rotation suppressing portion 56 suppresses rotation of the robot pedestal 14 relative to the molding machine base 12 about the pin axis of the pin member 38. Thus, the robot pedestal 14 arranged at a position away from the side surface of the molding machine base 12 can be coupled to the molding machine base 12 without rotating. Therefore, the robot pedestal 14 disposed at a position away from the side surface of the molding machine base 12 can be fixed to the molding machine base 12.

The above-described embodiment may be modified as follows.

### (Modification 1)

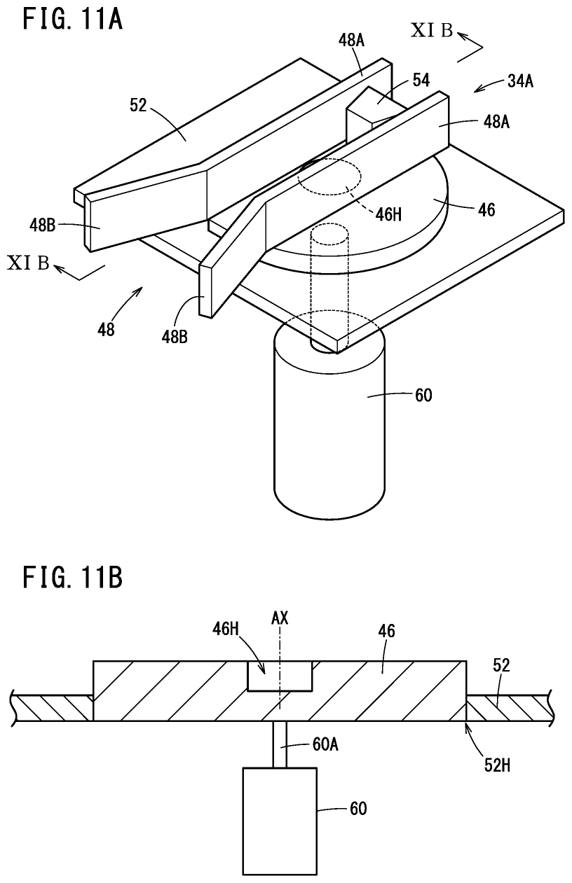

FIG. 11A is a diagram showing part of the first coupling unit 34A of the first modification. FIG. 11B is a cross-sectional view taken along the line XIB-XIB. In FIGS. 11A and 11B, the second pin receiving member 50 of the first coupling unit 34A is omitted. In FIGS. 11A and 11B, components equivalent to those described in the embodiment are denoted by the same reference numerals. In this modification, the description that overlaps with the embodiment is omitted.

In this modified example, the shape of the pin receiving member 46 is different from that in the embodiment and is formed in a disk shape. The shape of the pin receiving member 46 may be a shape other than a disk shape. Further, in this modified example, the insertion hole 46H does not penetrate the pin receiving member 46 (see FIG. 11B). The insertion hole 46H of the present modification is formed as a recess extending from the surface (upper surface) into which the pin member 38 is inserted toward the back surface (lower surface) but not reaching the back surface. Further, in this modified example, the size of the support member 52 is formed larger than that in the embodiment.

The first coupling unit 34A of the present modification has a motor 60. The motor 60 drives the pin receiving member 46 to an arbitrary rotational position. The motor 60 has a rotary shaft 60A. The rotary shaft 60A is attached to the pin receiving member 46 so as to align with the central axis AX (FIG. 11B) of the insertion hole 46H. The motor 60 is fixed to the support member 52 by a fixing member (not shown) and is attached to the molding machine base 12 via the support member 52. The support member 52 of the present modification is formed with a through hole 52H (FIG. 11B), and the pin receiving member 46 is rotatably disposed in the through hole 52H.

Thus, the pin receiving member 46 of the present modification rotatably supports the guide member 48 and the stopper 54 and is driven to an arbitrary rotational position by the motor 60. Thus, the guide direction of the guide member 48 can be changed to an arbitrary position. Therefore, in this modified example, the guide direction of the guide member 48 can be set so as to become a route through which the robot pedestal 14 can move while avoiding peripheral devices of the molding machine base 12.

### (Modification 2)

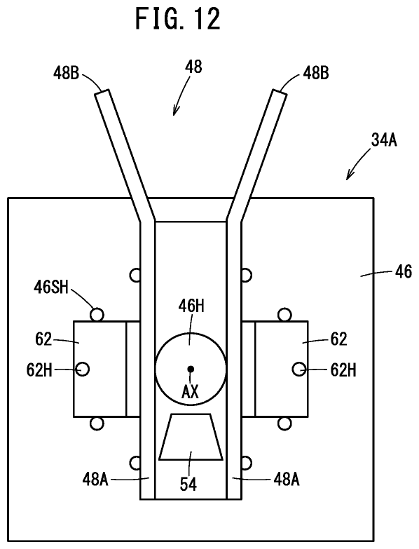

FIG. 12 is a view showing part of the first coupling unit 34A of Modification 2. In FIG. 12, the second pin receiving member 50 and the support member 52 of the first coupling unit 34A are omitted. In FIG. 12, components equivalent to those described in the embodiment are denoted by the same reference numerals. In this modification, the description that overlaps with the embodiment is omitted.

In this modified example, the size of the pin receiving member 46 is larger than that in the embodiment. The pin receiving member 46 is formed with a plurality of screw holes 46SH at intervals in the rotational direction. Each of the plurality of screw holes 46SH has the same shape and size. The distance from the central axis AX of the insertion hole 46H of the pin receiving member 46 to the center of each of the plurality of screw holes 46SH is the same.

The first coupling unit 34A of the present modification includes a fixing member 62. The fixing member 62 fixes the guide member 48 to the pin receiving member 46. The fixing member 62 is provided to each of the pair of first rails 48A. The fixing member 62 is provided with a through hole 62H through which a fastener such as a bolt that is screwed into the screw hole 46SH is inserted.

The operator screws the fastener inserted through the through hole 62H into one of the plurality of screw holes 46SH. As a result, the guide member 48 is fixed to the pin receiving member 46 at the position where the fastener is screwed.

As described above, in the present modification, the fixing member 62 is provided that fixes the guide member 48 to the pin receiving member 46 by using the fastener screwed into any of the plurality of screw holes 46SH formed in the pin receiving member 46. Thus, the guide direction of the guide member 48 can be changed to an arbitrary position by the operator. Therefore, the guide direction of the guide member 48 can be set so as to become a route through which the robot pedestal 14 can move while avoiding the peripheral devices of the molding machine base 12.

### (Modification 3)

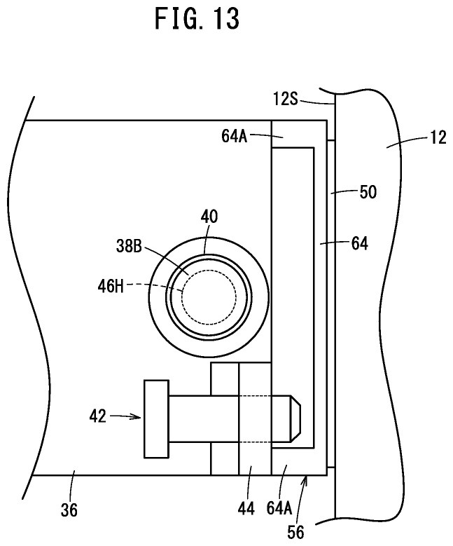

FIG. 13 is a schematic diagram showing a modification of the rotation suppressing portion 56 from the same viewpoint as FIG. 9. In FIG. 13, components equivalent to those described in the embodiment are denoted by the same reference numerals. In this modification, the description that overlaps with the embodiment is omitted.

The rotation suppressing portion 56 has a projection member 64 in place of the contact member 58 (FIG. 5B). The projection member 64 is provided to the molding machine base 12. The projection member 64 has a pair of projections 64A. When the molding machine base 12 and the robot pedestal 14 are coupled with each other by the coupling mechanism 34, the pair of projections 64A come into point-contact with the robot pedestal 14 with the pin axis of the pin member 38 interposed therebetween.

The pair of projections 64A may contact the side surface 14S of the robot pedestal 14. The pair of projections 64A may be in contact with part of the second coupling unit 34B. FIG. 13 shows a case where the pair of projections 64A is in contact with the base plate 36 of the second coupling unit 34B. Further, the projection member 64 may be divided into a first projection member having one of the pair of projections 64A and a second projection member having the other of the pair of projections 64A.

Even with such a projection member 64, similarly to the contact member 58 (FIG. 5B), the robot pedestal 14 can be prevented from rotating about the pin axis of the pin member 38 with respect to the molding machine base 12.

The rotation suppressing portion 56 may have both the contact member 58 of the embodiment (FIG. 5B) and the projection member 64 of the present modification. In this way, compared with the case where the rotation suppressing portion 56 has only either the contact member 58 (FIG. 5B) or the projection member 64, the force for suppressing the rotation of the robot pedestal 14 with respect to the molding machine base 12 can be increased.

The projection member 64 may be provided to the robot pedestal 14. In this case, the projection member 64 has a pair of projections that make point-contact with the molding machine base 12 with the pin axis of the pin member 38 interposed therebetween. Similarly, the contact member 58 (FIG. 5B) may be provided to robot pedestal 14. In this case, the contact member 58 is in surface-contact with the molding machine base 12 over both sides sandwiching the pin axis of the pin member 38.

### (Modification 4)

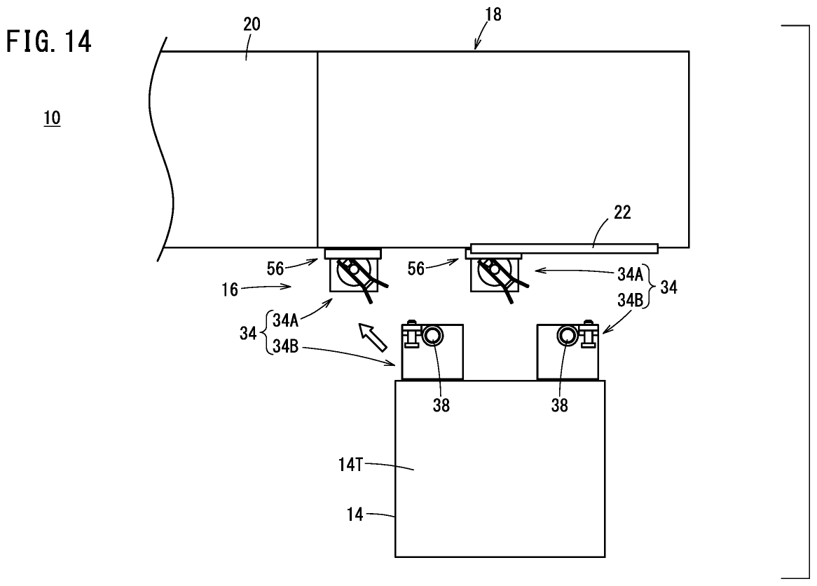

FIG. 14 is a schematic diagram showing a case where a plurality of coupling mechanisms 34 are provided. FIG. 14 is a top view of the mechanical system 10 of FIG. 1. In FIG. 14, the robot 24 is omitted. In FIG. 14, components equivalent to those described in the embodiment are denoted by the same reference numerals. In this modification, the description that overlaps with the embodiment is omitted.

In this modification, the fixing device 16 has a plurality of coupling mechanisms 34. Each of the plurality of coupling mechanisms 34 has the first coupling unit 34A of the modification 1 and the second coupling unit 34B of the embodiment. An arrow in FIG. 14 schematically indicates the guide direction described in the first modification or the second modification. In this modification, the first coupling unit 34A of the modification 1 can be changed to the first coupling unit 34A of the modification 2 or the first coupling unit 34A of the embodiment.

In a case where the fixing device 16 has a plurality of coupling mechanisms 34, the pin member 38 of each coupling mechanism 34 serves as the rotation suppressing portion 56. That is, the rotation suppressing portion 56 includes the pin member 38 of each of the plurality of coupling mechanisms 34. Thus, even if the contact member 58, the projection member 64, and the second pin member 42 are not provided, the robot pedestal 14 can be prevented from rotating about the pin axis of the pin member 38 with respect to the molding machine base 12. When at least one of the contact member 58, the projection member 64, and the second pin member 42 is provided, the suppressing force for suppressing the rotation of the robot pedestal 14 relative to the molding machine base 12 can be increased.

### (Modification 5)

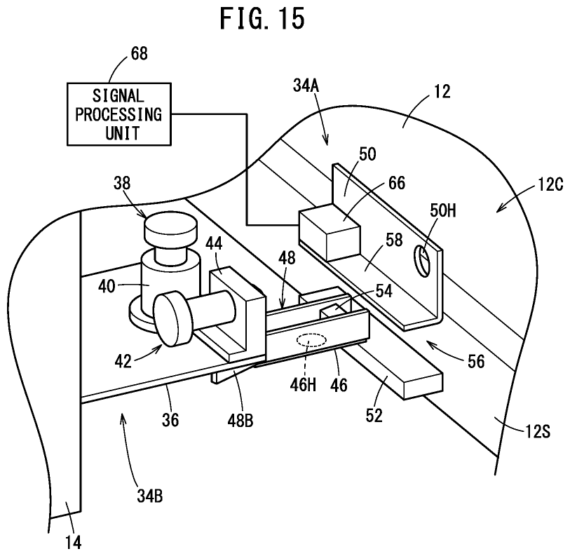

FIG. 15 is a diagram showing a modification of the fixing device 16 from the same viewpoint as FIG. 6. In FIG. 15, components equivalent to those described in the embodiment are denoted by the same reference numerals. In this modification, the description that overlaps with the embodiment is omitted.

The fixing device 16 of this modification includes a sensor 66 and a signal processing unit 68 connected to the sensor 66.

The sensor 66 detects the distance between the molding machine base 12 and the robot pedestal 14. The sensor 66 may be provided to the first coupling unit 34A, the second coupling unit 34B, the molding machine base 12, or the robot pedestal 14. FIG. 15 shows an example in which the sensor 66 is provided to the contact member 58 of the first coupling unit 34A.

The signal processing unit 68 may be incorporated into the sensor 66 or may be incorporated into a control device of an industrial machine (injection molding machine 18). When the molding machine base 12 and the robot pedestal 14 are coupled by the coupling mechanism 34, the signal processing unit 68 acquires the distance between the molding machine base 12 and the robot pedestal 14 from the sensor 66. The signal processing unit 68 monitors the amount of change in the distance between the molding machine base 12 and the robot pedestal 14.

When the amount of change in the distance between the molding machine base 12 and the robot pedestal 14 exceeds a threshold value, the signal processing unit 68 outputs a signal for stopping the industrial machine (injection molding machine 18) to the control device of the industrial machine. Thus, an unexpected accident or the like caused by a large change in the distance of the robot pedestal 14 to the molding machine base 12 can be prevented in advance.

### (Modification 6)

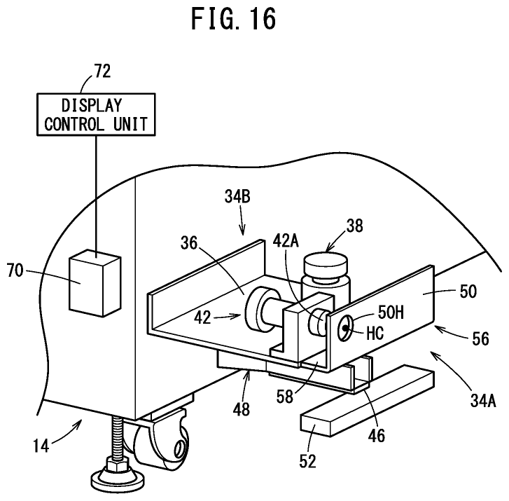

FIG. 16 shows another modification of the fixing device 16. In FIG. 16, components equivalent to those described in the embodiment are denoted by the same reference numerals. In this modification, the description that overlaps with the embodiment is omitted.

In the present modification, a sensor 70 and a display control unit 72 connected to the sensor 70 are newly provided.

The sensor 70 detects a height from the installation surface on which the robot pedestal 14 is installed. The sensor may be provided to the second coupling unit 34B or the robot pedestal 14. FIG. 16 shows an example in which the sensor 70 is provided to the robot pedestal 14.

The display control unit 72 may be incorporated in the sensor 70 or in the control device of the industrial machine (injection molding machine 18). The display control unit 72 acquires from the sensor 70 the height from the installation surface on which the robot pedestal 14 is installed.

Based on the height from the installation surface acquired from the sensor 70, the display control unit 72 calculates the height of the pin axis of the second pin member 42 with respect to the height of the insertion hole 50H formed in the second pin receiving member 50. The display control unit 72 causes a display unit to display the calculation result. Thus, without the operator adjusting the adjuster 32 (FIG. 3) while viewing the position of the pin axis with respect to the insertion hole the height of the robot pedestal 14 from the installation surface with respect to the molding machine base 12 can be accurately adjusted.

### (Modification 7)

The guide member 48 of the embodiment or the guide member 48 of Modification 2 may be provided directly on the molding machine base 12. Because the guide member 48 of Modification 1 rotates together with the pin receiving member 46, the guide member 48 cannot be directly provided on the molding machine base 12. As described above, the guide member 48 of Modification 1 is provided to the molding machine base 12 via the motor 60 and the support member 52. In the embodiment, the first coupling unit 34A is provided to the molding machine base 12 and the second coupling unit 34B is provided to the robot pedestal 14. However, the first coupling unit 34A may be provided to the robot pedestal 14 and the second coupling unit 34B may be provided to the molding machine base 12.

### (Modification 8)

The above-described embodiments and modifications may be arbitrarily combined within a range where no contradiction occurs.

### [Invention]

Hereinafter, the first invention and the second invention will be described as inventions that can be understood from the above-described embodiments and modifications.

### (First Invention)

The first invention is the fixing device (16) for fixing a second pedestal (14) to a first pedestal (12) including a coupling mechanism (34) that includes a pin member (38) extending in a direction perpendicular to an installation surface on which a pedestal is installed and that couples the first pedestal and the second pedestal with each other with the pin member, and a rotation suppressing portion (56) that suppresses rotation of the second pedestal about the pin axis of the pin member with respect to the first pedestal. Thus, the second pedestal disposed at a position away from the side surface of the first pedestal can be coupled to the first pedestal without rotating by using the pin member extending in the direction perpendicular to the installation surface. Therefore, the second pedestal arranged at a position away from the side surface of the first pedestal can be fixed to the first pedestal.

The rotation suppressing portion may include a contact member (58) provided to at least one of the first pedestal and the second pedestal in a manner so that when the first pedestal and the second pedestal are coupled by the coupling mechanism, the contact member makes surface-contact over both sides sandwiching the axis of the pin member and suppresses rotation. Thus, even if a plurality of coupling mechanisms are not provided, it is possible to prevent the second pedestal from rotating around the pin axis with respect to the first pedestal.

The rotation-suppressing part may be provided to at least one of the first pedestal and the second pedestal and may include the projection member (64) provided to at least one of the first pedestal and the second pedestal in a manner so that when the first pedestal and the second pedestal are coupled by the coupling mechanism, the projection member comes into contact on both sides of the axis of the pin member and suppresses rotation. Thus, even if a plurality of coupling mechanisms are not provided, it is possible to prevent the second pedestal from rotating around the pin axis with respect to the first pedestal.

The fixing device may include two or more of the coupling mechanisms, wherein the rotation suppressing portion may include the pin member of each of the coupling mechanisms. Thus, even if there is no contact member or projection member, the second pedestal can be prevented from rotating around the pin axis with respect to the first pedestal.

The coupling mechanism may include a second pin member (42) extending in a direction intersecting with the axis of the pin member and may couple the first pedestal and the second pedestal with each other using the pin member and the second pin member. As a result, displacement of the second pedestal relative to the first pedestal in the height direction can be suppressed. Further, the second pedestal can be prevented from rotating around the pin axis with respect to the first pedestal.

The second pedestal may include a plurality of legs (28) provided with an adjuster (32) that adjusts the height from the installation surface, and when the height from the installation surface is adjusted by the adjuster, the second pin member may position the height of the second mount from the installation surface with respect to the first pedestal. Thus, the height of the second pedestal relative to the first pedestal can be accurately adjusted.

The coupling mechanism may include a pin support member (40) that is provided to the second pedestal and slidably supports the pin member along the axial direction of the pin member, a pin receiving member (46) that is provided to the first pedestal and includes an insertion hole (46H) through which the pin member is inserted, and a guide member (48) that is provided to the first pedestal and guides the pin member into the insertion hole. Thus, the first pedestal and the second pedestal can be coupled by inserting the pin member through the insertion hole.

The guide member may include a pair of first rails (48A) that extends in one direction with an interval therebetween, and a pair of second rails (48B) that are provided at the ends of the pair of first rails and spread in a manner so that the interval increases as the distance from the insertion hole increases. Thus, the pin member can be inserted into the pair of first rails without forcing the operator to move the second pedestal viewing the pin member.

The coupling mechanism may include a motor (60) that includes a rotary shaft (60A) attached to the pin receiving member so as to align with the central axis (AX) of the insertion hole and which drives the pin receiving member to an arbitrary rotational position, and a support member (52) that is attached to the first pedestal and to which the motor is fixed. Thus, the guide direction of the guide member can be changed to an arbitrary position. Therefore, when the second pedestal is moved so that the pin member of the second pedestal enters between the pair of second rails of the first pedestal, the guide direction can be set so that it becomes a route to avoid the peripheral devices of the first pedestal.

The first pedestal may be a machine base of an industrial machine. Thus, a robot or the like that cooperates with the industrial machine can be installed on the second pedestal arranged at a position away from the side surface of the base of the industrial machine.

A fixing device may include a sensor (66) that detects the distance between the first pedestal and the second pedestal, and a signal processing unit (68) that outputs a signal for stopping the industrial machine when the amount of change in the distance when the first pedestal and the second pedestal are coupled by the coupling mechanism exceeds a threshold value. Thus, it is possible to prevent an accident or the like caused by a large change in the distance between the first pedestal and the second pedestal.

The industrial machine may be an injection molding machine 18 or a machine tool. Thus, a robot or the like that cooperates with an injection molding machine or a machine tool can be installed on the second pedestal.

### (Second Invention)

A second invention is a mechanical system (10) that includes the fixing device, an industrial machine including the first pedestal, and a robot (24) placed on the second pedestal. The mechanical system (10) is provided with the fixing device. Therefore, the second pedestal disposed at a position away from the side surface of the first pedestal can be coupled to the first pedestal without rotating by using the pin member extending in the direction perpendicular to the installation surface. Therefore, the second pedestal arranged at a position away from the side surface of the first pedestal can be fixed to the first pedestal.

1. A fixing device for fixing a second pedestal to a first pedestal, comprising:
a coupling mechanism that includes a pin member extending in a direction perpendicular to an installation surface on which a pedestal is installed and that couples the first pedestal and the second pedestal with each other with the pin member; and
a rotation suppressing portion that suppresses rotation of the second pedestal about a pin axis of the pin member with respect to the first pedestal.

2. The fixing device according to claim 1, wherein
the rotation suppressing portion includes a contact member provided to at least one of the first pedestal or the second pedestal in a manner so that when the first pedestal and the second pedestal are coupled by the coupling mechanism, the contact member makes surface-contact over both sides sandwiching the axis of the pin member and suppresses the rotation.

3. The fixing device according to claim 1, wherein
the rotation suppressing portion is provided to at least one of the first pedestal or the second pedestal, and includes a projection member provided to at least one of the first pedestal or the second pedestal in a manner so that when the first pedestal and the second pedestal are coupled by the coupling mechanism, the projection member comes into contact on both sides of the axis of the pin member and suppresses the rotation.

4. The fixing device according to claim 1, further comprising two or more of the coupling mechanisms,
wherein the rotation suppressing portion includes the pin member of each of the coupling mechanisms.

5. The fixing device according to claim 1, wherein
the coupling mechanism includes a second pin member extending in a direction intersecting with the axis of the pin member, and couples the first pedestal and the second pedestal using the pin member and the second pin member.

6. The fixing device according to claim 5,
wherein
the second pedestal includes a plurality of legs provided with an adjuster that adjusts a height from the installation surface, and
when the height from the installation surface is adjusted by the adjuster, the second pin member positions the height of the second pedestal from the installation surface relative to the first pedestal.

7. The fixing device according to claim 1, wherein
the coupling mechanism comprises:
a pin support member that is provided to the second pedestal and slidably supports the pin member along an axial direction of the pin member;
a pin receiving member that is provided to the first pedestal and includes an insertion hole through which the pin member is inserted; and
a guide member that is provided to the first pedestal and guides the pin member to the insertion hole.

8. The fixing device according to claim 7, wherein
the guide member includes a pair of first rails that extends in one direction with an interval therebetween, and a pair of second rails that are provided at ends of the pair of first rails and spread in a manner so that the interval increases as a distance from the insertion hole increases.

9. The fixing device according to claim 7, wherein
the coupling mechanism includes
a motor that includes a rotary shaft attached to the pin receiving member so as to align with a central axis of the through hole and drives the pin receiving member to a desired rotational position, and
a support member that is attached to the first pedestal and to which the motor is fixed.

10. The fixing device according to claim 1, wherein the first pedestal is a machine base of an industrial machine.

11. The fixing device according to claim 10, further comprising:
a sensor that detects a distance between the first pedestal and the second pedestal; and
a signal processing unit that outputs a signal for stopping the industrial machine when an amount of change in the distance when the first pedestal and the second pedestal are coupled with each other by the coupling mechanism exceeds a threshold value.

12. The fixing device according to claim 10, wherein the industrial machine is an injection molding machine or a machine tool.

13. A mechanical system comprising:
the fixing device according to claim 1;
an industrial machine including the first pedestal; and
a robot placed on the second pedestal.

14. The fixing device according to claim 2, wherein
the rotation suppressing portion is provided to at least one of the first pedestal or the second pedestal, and includes a projection member provided to at least one of the first pedestal or the second pedestal in a manner so that when the first pedestal and the second pedestal are coupled by the coupling mechanism, the projection member comes into contact on both sides of the axis of the pin member and suppresses the rotation.
